(19) United States
(12) Patent Application Publication
(10) Pub. No.: US 2018/0051766 A1
(43) Pub. Date: Feb. 22, 2018

(54) CYLINDER DEVICE

(71) Applicant: Hitachi Automotive Systems, Ltd., Ibaraki (JP)

(72) Inventor: Hiroshi YAMAGAI, Ibaraki (JP)

(21) Appl. No.: 15/562,357

(22) PCT Filed: Sep. 26, 2016
(86) PCT No.: PCT/JP2016/078156

§ 371 Date: Sep. 27, 2017

(30) Foreign Application Priority Data
Sep. 30, 2015 (JP) 2015-192850

(51) Int. Cl. F16F 9/346; F16F 9/53; F16F 9/32

(52) U.S. Cl. CPC F16F 9/346; F16F 9/53; F16F 9/3235; F16F 2230/02; F16F 2230/36; F16F 2224/043; F16F 2224/045; F16F 2230/18

(57) ABSTRACT

Provided is a cylinder device whereby it is possible to easily change and distinguish (identify) damping force characteristics. This cylinder device is equipped with: an inner cylinder in which a function fluid, which is changed in fluid properties by an electrical field or a magnetic field, is sealed, and into which a rod is inserted; a cylindrical member which is provided outside of the inner cylinder, and serves as an electrode or a magnetic pole; and a flow path forming member which is provided between the inner cylinder and the cylindrical member, and forms one or more flow paths through which the functional fluid flows from one end to the other end in the axial direction of the cylinder device in response to the forward and backward movement of the rod. The flow paths are spiral or meander flow paths having circumferentially-extending portions. The flow path forming member is formed with notches which cause axially adjacent portions among the flow paths to communicate with each other.

### TECHNICAL FIELD

The present invention relates to a cylinder device that is properly used for buffering a vibration of a vehicle such as, for example an automobile.

### BACKGROUND

In general, in a vehicle such as an automobile, a cylinder device represented by a hydraulic shock absorber is provided between a vehicle body (sprung) side and each vehicle wheel (unsprung) side. Here, Patent Document 1 discloses a configuration of a damper (shock absorber) using an electrorheological fluid in which helical members are provided between an inner cylinder and an outer cylinder and a flow path is defined between the helical members.

### PRIOR ART DOCUMENT

### Patent Document

Patent Document 1: International Publication No. WO 2014/135183

### DISCLOSURE OF THE INVENTION

### Problems to be Solved

However, the cylinder device needs to change damping force characteristics depending on, for example, the type, size, form and specifications of a vehicle which is equipped with the cylinder device. In this case, for example, it is conceivable to change damping force characteristics by changing the angle of the helical members. However, in this case, it may be troublesome to change and distinguish (identify) damping force characteristics.

An object of the present invention is to provide a cylinder device capable of easily changing and distinguishing (identifying) damping force characteristics.

### Means to Solve the Problems

A cylinder device according to an exemplary embodiment of the present invention includes: an inner cylinder in which a function fluid, a property of which is changed by an electric field or a magnetic field, is encapsulated and into which a rod is inserted; a cylinder member provided outside the inner cylinder and functioning as an electrode or a magnetic pole; and a flow path forming member provided between the inner cylinder and the cylinder member so as to form one flow path or a plurality of flow paths in which the functional fluid flows from one end side to the other end side of the cylinder device in an axial direction by advancing and retracting movements of the rod. The flow path is a helical or meander flow path having a portion that extends in a circumferential direction, and the flow path forming member has a notch formed therein to make portions of the flow path, which are adjacent to each other in the axial direction, communicate with each other.

### Effect of the Invention

According to a cylinder device of an exemplary embodiment of the present invention, it is possible to easily change and distinguish (identify) damping force characteristics.

### BRIEF DESCRIPTION OF THE DRAWINGS

FIG. 1 is a longitudinal cross-sectional view illustrating a shock absorber as a cylinder device according to a first exemplary embodiment.

FIG. 2 is a perspective view illustrating a ring-shaped member of FIG. 1.

FIG. 3 is a developed view illustrating an inner cylinder and the ring-shaped member which is developed along a column portion.

FIG. 4 is a side view of the ring-shaped member.

FIG. 5 is a plan view of the ring-shaped member.

FIG. 6 is a side view illustrating the inner cylinder and partition walls of the shock absorber according to a second exemplary embodiment.

FIG. 7 is a developed view illustrating the inner cylinder and the partition walls of FIG. 6.

### DETAILED DESCRIPTION TO EXECUTE THE INVENTION

Hereinafter, a case where a cylinder device according to an exemplary embodiment is applied to a shock absorber, which is provided in a vehicle such as, for example, a four-wheeled automobile, will be described, as an example with reference to the accompanying drawings.

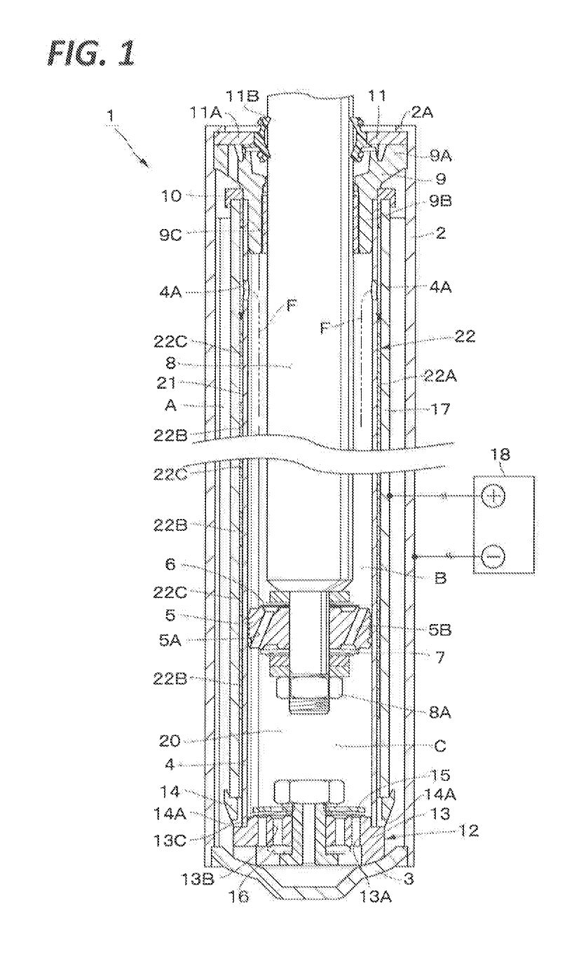

FIGS. 1 to 3 illustrate a first exemplary embodiment. In FIG. 1, a shock absorber 1 as a cylinder device is configured as a hydraulic shock absorber (semi-active damper) of a damping force regulation type, which uses a functional fluid (i.e., an electrorheological fluid) as a working oil (the working fluid 20 to be described later) encapsulated therein. The shock absorber 1 constitutes a vehicular suspension device, together with a suspension spring (not illustrated), which is formed of, for example, a coil spring. In addition, in the following description, it is assumed that one end side of the shock absorber 1 in the axial direction is referred to as an “upper end” side and the other end side in the axial direction is referred to as a “lower end” side.

The shock absorber 1 includes, for example, an outer cylinder 2, an inner cylinder 4, a piston 5, a piston rod 8, an electrode cylinder 17, and a ring-shaped member 22. The outer cylinder 2 is an outer shell of the shock absorber 1 and is formed as a cylinder body. The lower end side of the outer cylinder 2 is a closed end that is closed by a bottom cap 3 using, for example, a welding process.

The bottom cap 3 constitutes a base member together with a valve body 13 of a bottom valve 12 to be described later. The upper end side of the outer cylinder 2 is an open end, and a caulking portion 2A is formed on the open end side to be bent inward in the radial direction. The caulking portion 2A holds the outer circumferential side of an annular plate 11A of a seal member 11 in a locked state.

The inner cylinder 4 is formed as a cylinder body that has a cylindrical shape and extends in the axial direction, and the working fluid 20 (i.e., a functional fluid) to be described later is encapsulated in the inner cylinder 4. The inner cylinder 4 is provided within the outer cylinder 2 coaxially with the outer cylinder 2, and the piston rod 8 to be described later is inserted into the inner cylinder 4. The lower end side of the inner cylinder 4 is fitted and mounted to the valve body 13 of the bottom valve 12, and the upper end side thereof is fitted and mounted to a rod guide 9. The inner cylinder 4 is formed with multiple (e.g., four) oil holes 4A, which continuously communicate with a flow path 21 to be described later and are formed as radial horizontal holes to be spaced apart from one another in the circumferential direction. A rod side oil chamber B inside the inner cylinder 4 communicates with the flow path 21 through the oil holes 4A.

The inner cylinder 4 constitutes a cylinder together with the outer cylinder 2, and the working fluid 20 is encapsulated in the inner cylinder 4. Here, in the exemplary embodiment, an electrorheological fluid (ERF) is used as the working fluid 20 that is a fluid filled (encapsulated) in the cylinder, that is, a working oil. In addition, in FIG. 1, the encapsulated working fluid 20 is colorless and transparent.

The electrorheological fluid is a type of functional fluid, the fluid properties of which are changed by an electric field, and the properties of the electrorheological fluid are changed by an electric field (voltage). That is, the electrorheological fluid is changed in flow resistance (damping force) depending on a voltage applied thereto. The electrorheological fluid is composed of, for example, a base oil formed of, for example, silicone oil, and particles (fine particles) mixed (dispersed) in the base oil so as to make viscosity variable depending on a change in electric field. The shock absorber 1 is configured to control (regulate) damping force to be generated by generating a potential difference in the flow path 21 to be described later and controlling the viscosity of the electrorheological fluid passing through the flow path 21. In addition, in the exemplary embodiment, a functional fluid such as, for example, the electrorheological fluid will be described as an example, but a working liquid such as, for example, oil or water may be used.

An annular reservoir chamber A is formed between the inner cylinder 4 and the outer cylinder 2. A gas serving as a working gas is encapsulated in the reservoir chamber A together with the working fluid 20. The gas may be air in the atmospheric state, or a gas such as, for example, compressed nitrogen gas may be used. The gas in the reservoir chamber A is compressed so as to compensate for the volume of the piston rod 8 introduced thereinto when the piston rod 8 retracts (retraction stroke).

The piston 5 is slidably fitted (inserted) into and mounted in the inner cylinder 4. The piston 5 divides the inside of the inner cylinder 4 into the rod side oil chamber B and a bottom side oil chamber C. Multiple oil paths 5A and 5B are formed in the piston 5 to be spaced apart from one another in the circumferential direction, in order to enable communication between the rod side oil chamber B and the bottom side oil chamber C. Here, the shock absorber 1 according to the exemplary embodiment has a uniflow structure. Therefore, the working fluid 20 inside the inner cylinder 4 always circulates in one direction (i.e., in the direction of the arrow F indicated by the two-dot chain line of FIG. 1) from the rod side oil chamber B (i.e., the oil holes 4A in the inner cylinder 4) toward the flow path 21 during both the retraction stroke and the extension stroke of the piston rod 8.

In order to implement such a uniflow structure, for example, a retraction side check valve 6 is provided on the upper end surface of the piston 5 so that it is opened when the piston 5 slidably moves downward in the inner cylinder 4 during the retraction stroke of the piston rod 8, but is closed otherwise. The retraction side check valve 6 permits the oil liquid (working fluid 20) in the bottom side oil chamber C to circulate toward the rod side oil chamber B through each oil path 5A, but suppresses the oil liquid from flowing in the reverse direction thereof.

For example, an extension side disk valve 7 is provided on the lower end surface of the piston 5. The extension side disk valve 7 is opened when the pressure in the rod side oil chamber B exceeds a set relief pressure while the piston 5 slidably moves upward in the inner cylinder 4 during the extension stroke of the piston rod 8. The pressure at this time is relieved to the side of the bottom side oil chamber C through each oil path 5B.

The piston rod 8 is a rod that extends in the inner cylinder 4 in the axial direction (the same direction as the center axis of the inner cylinder 4 and the outer cylinder 2, and in turn, the shock absorber 1, and the vertical direction in FIG. 1). The lower end side of the piston rod 8 is connected (fixed) to the piston 5 in the inner cylinder 4. That is, the piston 5 is fixed (adhered) to the lower end side of the piston rod 8 using, for example, a nut 8A. On the other hand, the upper end side of the piston rod 8 extends to the outside of the inner cylinder 4 and the outer cylinder 2, which constitute the cylinder. That is, the upper end side of the piston rod 8 protrudes to the outside through the rod guide 9. In addition, the lower end of the piston rod 8 may further extend so as to protrude outward from the bottom side (e.g., the bottom cap 3), so that so-called both rods may be formed.

The rod guide 9 is provided in the upper end side (one end side) of the inner cylinder 4 and the outer cylinder 2. The rod guide 9 is fitted into the inner cylinder 4 and the outer cylinder 2 so as to close the upper end side of the inner cylinder 4 and the outer cylinder 2. The rod guide 9, which supports the piston rod 8, is formed as a cylinder body having a predetermined shape (a stepped cylindrical shape) by performing, for example, a molding process or a cutting process on, for example, a metal material or a hard resin material because it supports the piston rod 8. The rod guide 9 positions the upper portion of the inner cylinder 4 and the upper portion of the electrode cylinder 17 to be described later at the center of the outer cylinder 2. At the same time, the rod guide 9 guides the piston rod 8 to be slidable in the axial direction on the inner circumferential side thereof.

The rod guide 9 is formed in a stepped cylindrical shape by an annular large-diameter portion 9A, which is located on the upper side and is inserted into and mounted to the inner circumferential side of the outer cylinder 2, and a short cylindrical small-diameter portion 9B, which is located below the large-diameter portion 9A and is inserted into and mounted to the inner circumferential side of the inner cylinder 4. A guide portion 9C is provided on the inner circumferential side of the small-diameter portion 9B of the rod guide 9 to guide the piston rod 8 so as to be slidable in the axial direction. The guide portion 9C is formed, for example, by performing tetrafluoroethylene coating on the inner circumferential surface of a metal cylinder.

Meanwhile, an annular holding member 10 is fitted and mounted between the large-diameter portion 9A and the small-diameter portion 9B on the outer circumferential side of the rod guide 9. The holding member 10 holds the upper end side of the electrode cylinder 17 to be described later so as to be positioned in the axial direction. The holding member 10 is formed of, for example, an electrically insulating material (isolator), and holds the inner cylinder 4, the rod guide 9, and the electrode tube 17 so as to be electrically insulated from each other.

The seal member 11 is provided between the large-diameter portion 9A of the rod guide 9 and the caulking portion 2A of the outer cylinder 2. The entire seal member 11 is formed in an annular shape. That is, the seal member 11 includes an annular plate 11A, which is centrally provided with a hole, through which the piston rod 8 is inserted, and is formed of a metal, and an annular elastic body 11B, which is bonded to the annular plate 11A by means of, for example, baking and is formed of an elastic material such as, for example, rubber. The seal member 11 seals the space between the seal member 11 and the piston rod 8 in a liquid-tight and gastight manner as the inner periphery of the elastic body 11B comes into slide contact with the outer circumferential side of the piston rod 8.

The bottom valve 12 is located on the lower end side (the other end side) of the inner cylinder 4 and is provided between the inner cylinder 4 and the bottom cap 3. The bottom valve 12 includes the valve body 13, an extension side check valve 15, and a disk valve 16. The valve body 13 separates the reservoir chamber A and the bottom side oil chamber C from each other between the bottom cap 3 and the inner cylinder 4. Oil paths 13A and 13B are formed in the valve body 13 be spaced apart from each other in the circumferential direction, in order to enable communication between the reservoir chamber A and the bottom side oil chamber C.

A stepped portion 13C is formed on the outer circumferential side of the valve body 13, and the inner circumferential side of the lower end of the inner cylinder 4 is fixedly fitted to the stepped portion 13C. In addition, an annular holding member 14 is provided on the stepped portion 13C to be fitted and mounted to the outer circumferential side of the inner cylinder 4. The holding member 14 holds the lower end side of the electrode cylinder 17 to be described later to be positioned in the axial direction. The holding member 14 is formed of, for example, an electrically insulating material (isolator), and holds the inner cylinder 4, the valve body 13, and the electrode tube 17 to be electrically insulated from each other. In addition, multiple oil paths 14A are formed in the holding member 14 so as to allow the flow path 21 to be described later to communicate with the reservoir chamber A.

The extension side check valve 15 is provided, for example, on the upper surface side of the valve body 13. The extension side check valve 15 is opened when the piston 5 slidably moves upward during the extension stroke of the piston rod 8, but is closed otherwise. The extension side check valve 15 permits the oil liquid (working fluid 20) in the reservoir chamber A to circulate toward the bottom side oil chamber C through each oil path 13A, but suppresses the oil liquid from flowing in the reverse direction.

The retraction side disk valve 16 is provided, for example, on the lower surface side of the valve body 13. The retraction side disk valve 16 is opened when the pressure in the bottom side oil chamber C exceeds a set relief pressure while the piston 5 slidably moves downward during the retraction stroke of the piston rod 8, and the pressure at this time is relieved to the side of the reservoir chamber A through each oil path 13B.

The electrode cylinder 17 is a cylinder member (intermediate cylinder) provided outside the inner cylinder 4. That is, the electrode cylinder 17 is configured with a pressure tube, which extends in the axial direction between the outer cylinder 2 and the inner cylinder 4. The electrode cylinder 17 is formed in a cylindrical shape using a conductive material, thereby configuring a cylindrical electrode. The electrode cylinder 17 is attached to the outer circumferential side of the inner cylinder 4 via the holding members 10 and 14, which are provided in the axial direction (the vertical direction) to be spaced apart from each other. In this case, the upper end side of the electrode cylinder 17 is configured not to be rotatable relative to the outer cylinder 2 with, for example, the holding member 10 and the rod guide 9 interposed therebetween. The lower end side of the electrode cylinder 17 is configured not to be rotatable relative to the outer cylinder 2 with, for example, the holding member 14, the valve body 13, and the bottom cap 3 interposed therebetween.

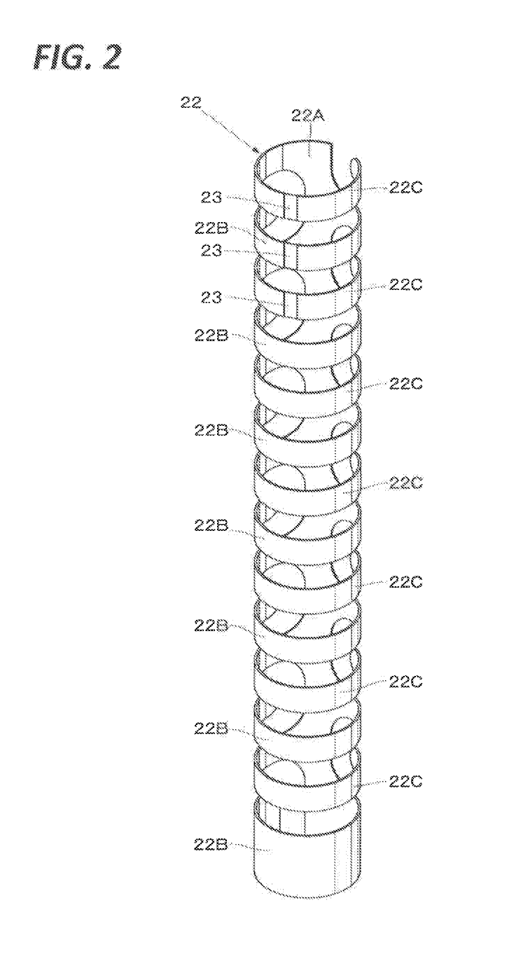

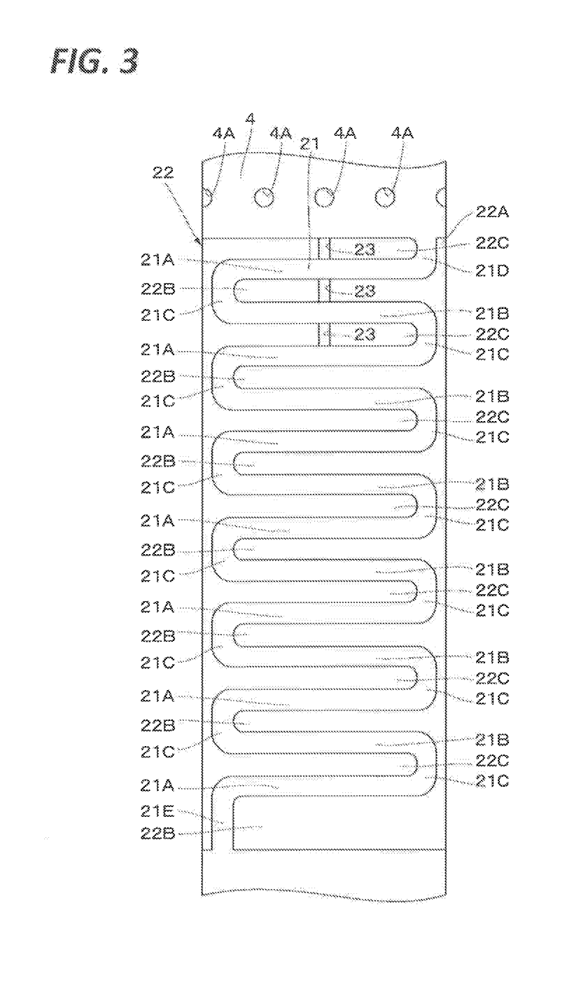

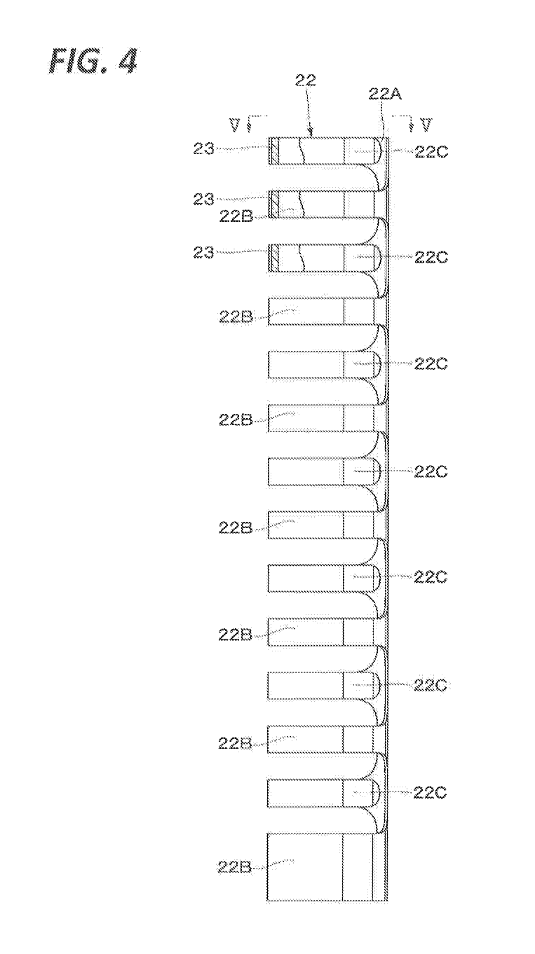

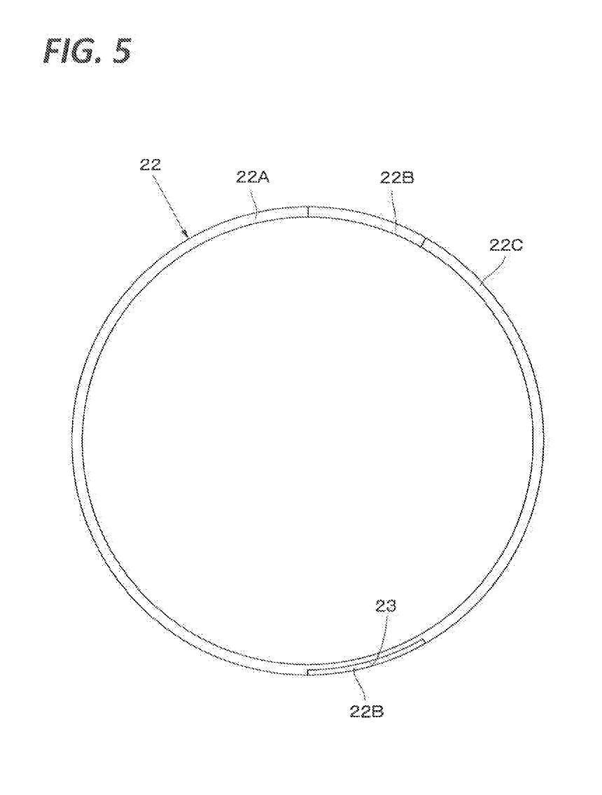

By surrounding the outer circumferential side of the inner cylinder 4 over the entire periphery thereof, the electrode cylinder 17 forms a flow path (passage or an oil path) therein (between the inner circumferential side of the electrode cylinder 17 and the outer circumferential side of the inner cylinder 4), i.e. the flow path 21 in which the working fluid 20 flows (circulates). In this case, the ring-shaped member 22 illustrated in FIGS. 2 to 5 to be described later is provided between the inner circumferential side of the electrode cylinder 17 and the outer circumferential side of the inner cylinder 4. Thus, as illustrated in FIG. 3, the flow path 21 is a meander flow path defined by the ring-shaped member 22. Therefore, the overall length of the flow path 21 may be longer than a flow path that linearly extends in the axial direction.

The flow path 21 continuously communicates with the rod side oil chamber B through the oil holes 4A, which are formed as radial horizontal holes in the inner cylinder 4. That is, considering the direction of the flow of the working fluid 20 indicated by the arrow F in FIG. 1, during both the compression stroke and the extension stroke of the piston 5, the shock absorber 1 introduces the working fluid 20 from the rod side oil chamber B into the flow path 21 through the oil holes 4A. When the piston rod 8 performs advancing and retracting movements in the inner cylinder 4 (that is, while the retraction stroke and the extension stroke are repeated), the working fluid 20 introduced into the flow path 21 moves from the upper end side to the lower end side of the flow path 21 in the axial direction by the advancing and retracting movements.

The working fluid 20 introduced into the flow path 21 is discharged from the lower end side of the electrode cylinder 17 to the reservoir chamber A through the oil paths 14A of the holding member 14. At this time, the pressure of the working fluid 20 is the highest at the upstream side of the flow path 21 (i.e., on the side of the oil holes 4A), and gradually decreases while circulating in the flow path 21 because it receives a flow path resistance (path resistance). Therefore, the working fluid 20 in the flow path 21 has the lowest pressure when circulating in the downstream side of the flow path 21 (i.e., the oil paths 14A of the holding member 14).

The flow path 21 imparts a resistance to the fluid, which is circulated by the sliding of the piston 5 in the outer cylinder 2 and the inner cylinder 4, that is, the electrorheological fluid that serves as the working fluid 20. Therefore, the electrode cylinder 17 is connected to a positive electrode of a battery 18, which serves as a power source, via, for example, a high voltage driver (not illustrated), which generates a high voltage. The electrode cylinder 17 is an electrode that applies an electric field (voltage) to the working fluid 20 that is the fluid in the flow path 21, that is, the electrorheological fluid as a functional fluid. In this case, both end sides of the electrode cylinder 17 are electrically insulated by the electrically insulating holding members 10 and 14. On the other hand, the inner cylinder 4 is connected to a negative electrode (ground) via, for example, the rod guide 9, the bottom valve 12, the bottom cap 3, the outer cylinder 2, and the high voltage driver.

The high voltage driver boosts a direct current (DC) voltage output from the battery 18 based on a command (high voltage command), which is output from a controller (not illustrated) for variably regulating the damping force of the shock absorber 1, thereby supplying (outputting) the DC voltage to the electrode cylinder 17. Thus, a potential difference depending on the voltage applied to the electrode cylinder 17 occurs between the electrode cylinder 17 and the inner cylinder 4, in other words, in the flow path 21, and the viscosity of the working fluid 20, which is the electrorheological fluid, is changed. In this case, the shock absorber 1 may successively regulate characteristics of damping force to be generated (damping force characteristics) from hard characteristics to soft characteristics based on the voltage applied to the electrode cylinder 17. In addition, the shock absorber 1 may regulate the damping force characteristics in two stages or in multiple stages even if the regulation is not successive.

Next, the flow path 21, which is formed between the electrode cylinder 17 and the inner cylinder 4, and the ring-shaped member 22, which is a flow path forming member that forms the flow path 21, will be described with reference to FIGS. 2 to 5, in addition to FIG. 1.

First, the flow path 21 will be described. As illustrated in FIG. 3, the flow path 21 is a meander flow path having a portion that extends in the circumferential direction. That is, the flow path 21 has one portion, which extends in a first circumferential direction (e.g., in a clockwise direction when viewed from the side of the caulking portion 2A of the outer cylinder 2), and the other portion, which extends in a second circumferential direction (e.g., in a counterclockwise direction, which is opposite to the first circumferential direction, when viewed from the side of the caulking portion 2A of the outer cylinder 2). In addition, the one portion and the other portion are connected to each other by a connecting portion that is a turning-back portion.

That is, the flow path 21 includes a clockwise path 21A as a first peripheral path, which extends in the first circumferential direction, a counterclockwise path 21B as a second peripheral path, which extends in the second circumferential direction, and a turning-back path 21C, which interconnects the clockwise path 21A and the counterclockwise path 21B. In a first exemplary embodiment, the number of clockwise paths 21A is set to 7, the number of counterclockwise paths 21B is set to 6, and the number of turning-back paths 21C is set to 12. In addition, when viewing the shock absorber 1 (e.g., the inner cylinder 4, the electrode cylinder 17, and the ring-shaped member 22) from the upper end side (one end side) thereof in the axial direction, that is, when viewing the shock absorber 1 from the upper side to the lower side in FIG. 1, the terms “clockwise (right-turn)” and “counterclockwise (left-turn)” correspond to the circumferential direction around the axial center line of the shock absorber 1.

The upstream side (upper end side) of the flow path 21 is configured with an inflow path 21D, which extends in the axial direction. The inflow channel 21D serves as an inlet of a portion of the flow path 21 that is partitioned by the ring-shaped member 22 (i.e., a portion in which the working fluid 20 is guided to meander by the ring-shaped member 22). The working fluid 20, discharged from the rod side oil chamber B through the oil holes 4A, is introduced into the inflow path 21D. On the other hand, the downstream side (lower end side) of the flow path 21 forms an outflow path 21E, which extends in the axial direction. The outflow path 21E serves as an outlet of a portion of the flow path 21 that is partitioned by the ring-shaped member 22. The working fluid 20, discharged from the outflow path 21E, is discharged to the reservoir chamber A through the oil paths 14A of the holding member 14.

Next, the ring-shaped member 22 will be described. The ring-shaped member 22 defines the meander flow path 21 between the electrode cylinder 17 and the inner cylinder 4. Therefore, the ring-shaped member 22 is provided between the inner cylinder 4 and the electrode cylinder 17 to be coaxial with the inner cylinder 4 and the electrode cylinder 17. The ring-shaped member 22 defines the flow path 21 in which the working fluid 20 flows by the advancing and retracting movements of the piston rod 8 from the upper end side to the lower end side in the axial direction, between the inner cylinder 4 and the electrode cylinder 17. In other words, the ring-shaped member 22 partitions the flow path 21 (guides the working fluid 20) between the inner cylinder 4 and the electrode cylinder 17. The ring-shaped member 22 is formed of an insulator and is wholly formed in a substantially cylindrical shape. In this case, the ring-shaped member 22 is formed, for example, using a polymer material such as, for example, a polyamide-based resin or a thermosetting resin (a rubber material including a synthetic rubber or a resin material including a synthetic resin).

The ring-shaped member 22 is fitted into both the inner cylinder 4 and the electrode cylinder 17 by slight press-fitting. Then, the ring-shaped member 22 is bonded to the inner cylinder 4 using, for example, an adhesive. Thus, the inner circumferential surface of the ring-shaped member 22 is in (liquid-tight) contact with the outer circumferential surface of the inner cylinder 4 and the outer circumferential surface of the ring-shaped member 22 is in (liquid-tight) contact with the inner circumferential surface of the electrode cylinder 17. That is, the working fluid 20, which flows in the flow path 21, may not be discharged beyond a column portion 22A, a clockwise portion 22B, and a counterclockwise portion 22C of the ring-shaped member 22. In addition, the ring-shaped member 22 and the inner cylinder 4 may be provided, for example, with positioning portions (e.g., a concave portion and a convex portion), which position the ring-shaped member 22 so as not to rotate relative to the inner cylinder 4. In addition, a groove may be formed in the inner cylinder 4, and the ring-shaped member 22 may be fixed along the groove.

Here, the ring-shaped member 22 includes a column portion 22A, clockwise portions 22B, and counterclockwise portions 22C. In the first exemplary embodiment, the number of clockwise portions 22B is set to 7 and the number of counterclockwise portions 22C is set to 7. The column portion 22A extends in the axial direction between the inner cylinder 4 and the electrode cylinder 17 and has an arc-shaped cross-sectional shape.

The base end side of a clockwise portions 22B is connected to one circumferential side of a column portion 22A, and the base end side of a counterclockwise portion 22C is connected to the other circumferential side of the column portion 22A. Thus, the clockwise portion 22B and the counterclockwise portion 22C are connected to each other via the column portion 22A. In this case, the clockwise portions 22B and the counterclockwise portions 22C are arranged alternately in the axial direction of the ring-shaped member 22. In addition, a clockwise portions 22B and a counterclockwise portions 22C, which are adjacent to each other in the axial direction, face (oppose) each other with an interval therebetween in the axial direction. Thus, a clockwise path 21A or a counterclockwise path 21B of the flow path 21 is formed between a clockwise portion 22B and a counterclockwise portion 22C, which are adjacent to each other in the axial direction.

The clockwise portions 22B are disposed to be spaced apart from each other in the axial direction between the inner cylinder 4 and the electrode cylinder 17. Each clockwise portion 22B is a first peripheral portion (a first ring), which extends in the first circumferential direction from one circumferential side of the column portion 22A. That is, the base end side of the clockwise portion 22B is connected to one side of the column portion 22A. On the other hand, the tip end side of the clockwise portion 22B faces the other side of the column portion 22A at a distance therefrom. Thus, the turning-back path 21C of the flow path 21 is formed between the tip end side of the clockwise portion 22B and the other side of the column portion 22A. That is, a connecting portion for forming the turning-back path 21C of the flow path 21 is formed between a portion (the other side) of the column portion 22A and the counterclockwise portion 22C, which is adjacent thereto in the axial direction.

The counterclockwise portions 22C are disposed to be spaced apart from each other in the axial direction between the inner cylinder 4 and the electrode cylinder 17. In this case, each counterclockwise portion 22C is disposed between the clockwise portions 22B, which are adjacent thereto in the axial direction. The counterclockwise portion 22C is a second peripheral portion (a second ring), which extends in the second circumferential direction from the other circumferential side of the column portion 22A. That is, the base end side of the counterclockwise portion 22C is connected to the other side of the column portion 22A. On the other hand, the tip end side of the counterclockwise portion 22C faces one side of the column portion 22A at a distance therefrom. Thus, the turning-back path 21C of the flow path 21 is formed between the tip end side of the counterclockwise portion 22C and one side of the column portion 22A. That is, a connecting portion for forming the turning-back path 21C of the flow path 21 is formed between a portion (one side) of the column portion 22A and the clockwise portion 22B, which is adjacent thereto in the axial direction.

Here, the axial dimension of the clockwise portion 22B and the axial dimension of the counterclockwise portion 22C are the same, except for the lowermost clockwise portion 22B. In addition, the dimension of a spacing dimension (axial interval) between the clockwise portion 22B and the counterclockwise portion 22C is the same as the axial dimension of the counterclockwise portion 22C. In addition, these dimensions may be appropriately adjusted, for example, to be different from each other, in order to obtain a desired damping force characteristic (the pressure loss of the flow path 21).

Patent Document 1 discloses a shock absorber in which helical members are provided between an inner cylinder and an outer cylinder and a flow path is defined between the helical members. Meanwhile, the shock absorber needs to change damping force characteristics based on, for example, the type (model), size, form, and specifications of a vehicle which is equipped with the shock absorber. In this case, for example, it is conceivable to adjust the length of the flow path and achieve different damping force characteristics by changing the angle of the helical members. That is, it is conceivable to change and distinguish (identify) damping force characteristics based on, for example, the type of a vehicle by preparing multiple types of elements, helical members of which have different angles, and selecting an element among the multiple types of elements, from which desired damping force characteristics may be obtained. However, it is difficult to visually determine the minute difference between the angles of the helical members, which may increase the difficulty of management of elements. In addition, because the respective elements include the helical members having different angles, mass production costs may increase.

Whereas, in the first exemplary embodiment, notches 23 are formed in the ring-shaped member 22 to interconnect the clockwise paths 21A and the counterclockwise paths 21 of the flow path 21. In addition, the pressure loss of the flow path 21 may be adjusted to easily change and distinguish (identify) damping force characteristics by adjusting, for example, the presence/absence of the notches 23, the number of notches 23, the positions at which the notches 23 are provided, and the size, the cross-sectional shape and the extending direction of the notches 23.

That is, each notch 23 allows the clockwise path 21A and the counterclockwise path 21B, which are portions (adjacent portions) of the flow path 21 adjacent to each other in the axial direction, to communicate with each other. The notch 23 is formed, for example, as a recessed groove, which extends in the axial direction, by performing cutting or pressing (coining) on the surface of the clockwise portion 22B or the counterclockwise portion 22C. The notch 23 allows the clockwise path 21A and the counterclockwise path 21B, which are adjacent to each other in the axial direction, to communicate with each other to form an oil path for allowing the working fluid 20 to circulate therein. Thus, the working fluid 20 circulates between the clockwise path 21A and the counterclockwise path 21B, which are adjacent to each other in the axial direction, not only through the turning-back path 21C, but also through the notch 23.

At this time, the notch 23 is a shortcut (bypass) oil path between the clockwise path 21A and the counterclockwise path 21B, which are adjacent to each other in the axial direction. Therefore, compared to a configuration having no notch 23, the configuration having the notch 23 may reduce, for example, a pressure loss, and may achieve soft damping force characteristics. In addition, for example, the pressure loss may be reduced and the soft damping force characteristic may be achieved by increasing the number of notches 23, by providing a greater number of notches 23 on the upstream side, by increasing the size (e.g., the width in the circumferential direction) of the notch 23, or by increasing the cross-sectional shape of the notch 23.

In addition, in the first exemplary embodiment, the notch 23 extends in the same direction as the axial center line of the ring-shaped member 22, but may extend, for example, obliquely (at a twisted position) with respect to the axial center line. In addition, the notch 23 is formed in a straight line to extend in the axial direction, but may be formed in, for example, a curved line or a combined line of a curved line and a straight line. In addition, the notch 23 has the same cross-sectional shape in the axial direction, but may be changed, for example, in a middle portion thereof such that the cross-sectional area thereof increases or decreases. That is, the notch 23 may be a recessed groove, which may allow the clockwise path 21A and the counterclockwise path 21B, which are portions adjacent to each other in the axial direction, to communicate with each other.

In addition, although one notch 23 is provided for one clockwise portion 22B or one counterclockwise portion 22C, for example, multiple notches 23 may be provided for one clockwise portion 22B or one counterclockwise portion 22C. In addition, the number of notches 23 provided in one clockwise portion 22B and the number of notches 23 provided in one counterclockwise portion 22C are the same, but may be, for example, different from each other. In addition, the notches 23 of the clockwise portions 22B and the notches 23 of the counterclockwise portions 22C are aligned in the axial direction, but may deviate from each other, for example, in the circumferential direction.

Here, in the first exemplary embodiment, the notch 23 is located at the upper side of the ring-shaped member 22 to be provided only on the upstream side of the flow path 21 in which the working fluid 20 flows. Specifically, among the clockwise portions 22B and the counterclockwise portions 22C, which extend in the circumferential direction, the notch 23 is provided in each of the clockwise and counterclockwise portions 22B and 22C from the upper side (one side), which is the upstream side of the circulation direction of the working fluid 20, to the third one. In this case, the expression “only on the upstream side” corresponds to, for example, “only between the upper end of the ring-shaped member 22 and half the entire axial length of the ring-shaped member 22”. Preferably, the expression corresponds to “only between the upper end of the ring-shaped member 22 and one-third of the entire axial length of the ring-shaped member 22”. More preferably, the expression corresponds to “only between the upper end of the ring-shaped member 22 and one fourth of the entire axial length of the ring-shaped member 22”. Most preferably, the expression corresponds to “only between the upper end of the ring-shaped member 22 and one fifth of the entire axial length of the ring-shaped member 22”.

In addition, in the first exemplary embodiment, although the notch 23 is provided in all of the clockwise and counterclockwise portions 22B and 22C from the upper side to the third one, for example, the notch 23 may be provided only in the first one from the upper side, or only in the first and second ones from the upper side. In addition, the notch 23 may be provided to the fourth one (or more) from the upper side. In addition, for example, as in a case where the notches 23 are provided in the first and third ones, a clockwise portion 22B or a counterclockwise portion 22C, which is not provided with the notch 23, may be provided between the uppermost clockwise portion 22B or counterclockwise portion 22C, which is provided with the notch 23, and the lowermost clockwise portion 22B or counterclockwise portion 22C, which is provided with the notch 23. In any case, for example, the number, the position, the size, the cross-sectional shape, and the extending direction of the notches 23 may be appropriately adjusted in order to obtain necessary damping force characteristics (the pressure loss of the flow path 21).

The shock absorber 1 according to the first exemplary embodiment has the above-described configuration, and an operation thereof will be described below.

When the shock absorber 1 is mounted in a vehicle such as, for example, an automobile, for example, the upper end side of the piston rod 8 is attached to the vehicle body side of the vehicle and the lower end side (the side of the bottom cap 3) of the outer cylinder 2 is attached to the wheel side (axle side). When vertical vibration is generated due to, for example, convex and concave portions of the road surface during the traveling of the vehicle, the piston rod 8 is displaced to extend from/retract into the outer cylinder 2. At this time, the damping force of the shock absorber 1 to be generated is variably regulated by generating a potential difference in the flow path 21 based on a command from a controller, and controlling the viscosity of the working fluid 20 passing through the flow path 21, i.e. the electrorheological fluid.

For example, during the extension stroke of the piston rod 8, the retraction side check valve 6 of the piston 5 is closed by the movement of the piston 5 in the inner cylinder 4. Before the disk valve 7 of the piston 5 is opened, the oil liquid (working fluid 20) in the rod side oil chamber B is pressurized and introduced into the flow path 21 through the oil holes 4A in the inner cylinder 4. At this time, the oil liquid, the amount of which corresponds to the extent of the movement of the piston 5, is introduced from the reservoir chamber A into the bottom side oil chamber C as the extension side check valve 15 of the bottom valve 12 is opened.

On the other hand, during the retraction stroke of the piston rod 8, the retraction side check valve 6 of the piston 5 is opened by the movement of the piston 5 in the inner cylinder 4, and the extension side check valve 15 of the bottom valve 12 is closed. Before the bottom valve 12 (the disk valve 16) is opened, the oil liquid in the bottom side oil chamber C is introduced into the rod side oil chamber B. At the same time, the oil liquid, the amount of which corresponds to the extent to which the piston rod 8 is introduced into the inner cylinder 4, is introduced from the rod side oil chamber B into the flow path 21 through the oil holes 4A in the inner cylinder 4.

In both cases (both during the extension stroke and the retraction stroke), the oil liquid introduced into the flow path 21 passes through the inside of the flow path 21 toward the outlet side (lower side) with a viscosity depending on the potential difference in the flow channel 21 (potential difference between the electrode cylinder 17 and the inner cylinder 4), and flows from the flow path 21 to the reservoir chamber A through the oil paths 14A of the holding member 14. At this time, the shock absorber 1 may generate a damping force (pressure loss) depending on the viscosity of the oil liquid that passes through the flow path 21, thereby absorbing (alleviating) the vertical vibration of the vehicle.

Here, the working fluid 20, which is the oil liquid introduced into the space between the inner cylinder 4 and the electrode cylinder 17 from the oil holes 4A in the inner cylinder 4, flows from the upper end side to the lower end side of the meander flow path 21, which is defined by the ring-shaped member 22. That is, the working fluid 20 flows in the following order: the inflow path 21D of the flow path 21→the clockwise path 21A→the turning-back path 21C→the counterclockwise path 21B→the turning-back path 21C→(omitted)→the clockwise path 21A→the outflow path 21E. At this time, at the upstream side, the working fluid 20 circulates not only through the turning back path 21C, but also through the notch 23 between the clockwise path 21A and the counterclockwise path 21B, which are adjacent to each other in the axial direction. In this case, because the notch 23 is a shortcut oil path between the clockwise path 21A and the counterclockwise path 21B, which are adjacent to each other in the axial direction, compared to a configuration having no notch 23, for example, soft damping force characteristics may be achieved.

In this way, in the first exemplary embodiment, the ring-shaped member 22 is formed with the notch 23, which allows the clockwise path 21A and the counterclockwise path 21B of the flow path 21, which are adjacent to each other in the axial direction, to communicate with each other. Therefore, for example, the shock absorber 1 of the first exemplary embodiment may achieve damping force characteristics different from those of a shock absorber, which is different from the shock absorber 1 only in terms that no notch is formed therein. In addition, the shock absorber 1 may achieve different damping force characteristics by changing the number of notches 23. That is, by changing at least one of, for example, the presence/absence of the notches 23 and the number, the position, the size, the cross-sectional shape, and the extending direction of the notches 23, the damping force characteristics of the shock absorber 1 may be changed (regulated or tuned) in various ways. In this case, visually determining (distinguishing or identifying) the difference in, for example, the presence/absence, the number, the position, the size, the cross-sectional shape, and the extending direction of the notches 23 may be easily carried out, compared to a case of visually determining, for example, the difference in the angle of the helical members. Thus, the management of elements may be easily performed.

Moreover, a change in damping force characteristics in various ways may be implemented by changing at least one of, for example, the number, position, size, cross-sectional shape, and extending direction of the notches 23 formed in the ring-shaped member 22. Therefore, it is possible to easily change (regulate) the damping force characteristics in various ways. In addition, the damping force characteristics may be changed (regulated) in various ways by manufacturing a ring-shaped member having no notch, and thereafter forming the notch 23 in the ring-shaped member so as to achieve desired damping force characteristics. Therefore, elements may be used in common, which may reduce mass production costs.

In the first exemplary embodiment, the notches 23 are provided only on the upstream side of the ring-shaped member 22 in which the working fluid 20 flows. Therefore, the damping force characteristics may be changed (regulated) in various ways by the notches 23 provided at a position at which the pressure of the working fluid 20 is high. Thus, for example, even if the number of notches 23 is not greatly changed (e.g., even if the difference in the number of notches 23 is set to one), the damping force characteristics may be changed. As a result, the degree of freedom of changing (regulating) the damping force characteristics may be increased (the range within which the damping force characteristics may be changed may be increased).

In the first exemplary embodiment, the ring-shaped member 22 is formed of an insulator. Therefore, even if the ring-shaped member 22 is in contact with both the electrode cylinder 17 and the inner cylinder 4, the electrode cylinder 17 and the inner cylinder 4 may be electrically insulated from each other.

In the first exemplary embodiment, the notches 23 are formed to extend in the axial direction. Therefore, the working fluid 20 may be circulated in the notches 23 in the axial direction. That is, the damping force characteristics may be changed (regulated) in various ways by the notches 23, which may linearly circulate the working fluid 20 from the upper side to the lower side in the axial direction. Even in this case, for example, even if, for example, the number of notches 23 is not greatly changed (e.g., even if the difference in the number of notches 23 is set to one), the damping force characteristics may be changed. Thus, the degree of freedom of changing (regulating) the damping force characteristics may be increased (the range within which the damping force characteristics may be changed may be increased).

In the first exemplary embodiment, the flow path 21 is a meander flow path having the clockwise portions 22B and the counterclockwise portions 22C, which are portions extending in the circumferential direction. More specifically, the flow path 21 includes the clockwise paths 21A, which extend in the first circumferential direction, and the counterclockwise paths 21B, which extend in the second circumferential direction, which is opposite to the first circumferential direction. Therefore, a rotational force, which is applied from the working fluid 20 flowing in the flow path 21 to the ring-shaped member 22, the inner cylinder 4, and the electrode cylinder 17, becomes opposite between the clockwise paths 21A and the counterclockwise path 21B. Thus, the rotational force applied from the working fluid 20 flowing in the flow path 21 may be reduced.

In this case, in the first exemplary embodiment, the force applied to the clockwise paths 21A and the force applied to the counterclockwise paths 21B are close to the same magnitude. In addition, the force applied to the turning-back paths 21C is also close to the same magnitude between the clockwise direction and the counterclockwise direction. Therefore, the rotational force in the first circumferential direction (clockwise direction) and the rotational force in the second circumferential direction (counterclockwise direction) may cancel each other so that the rotational force applied from the fluid flowing in the flow path 21 may be canceled (may be almost zero as a whole).

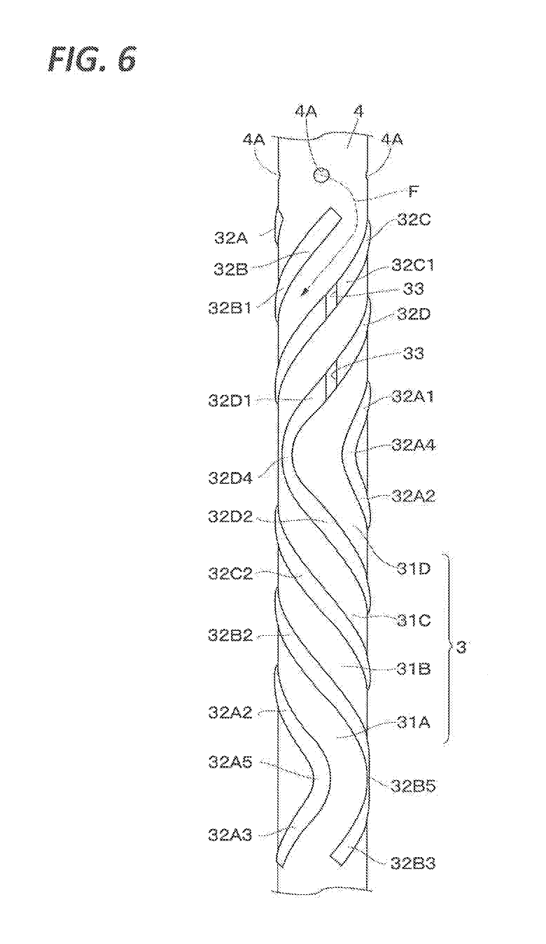

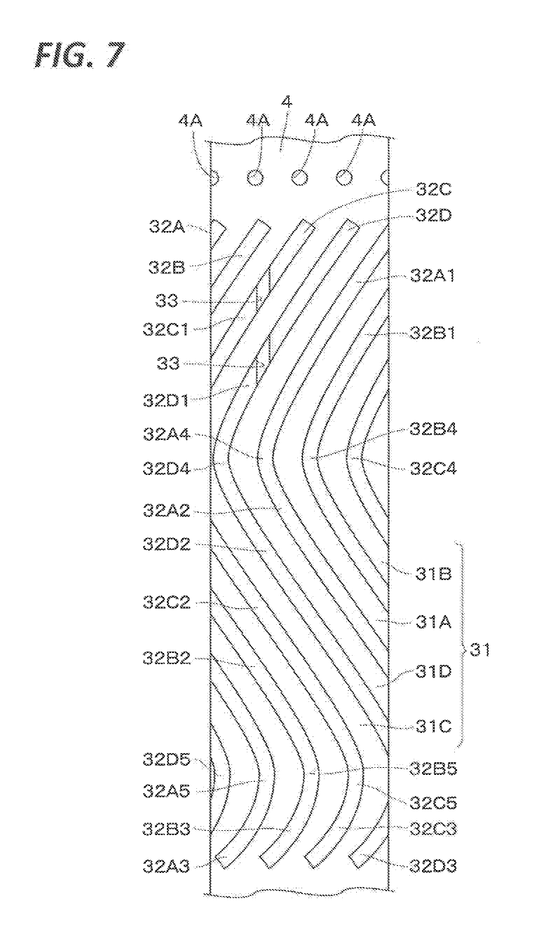

Next, FIGS. 6 and 7 illustrate a second exemplary embodiment. The second exemplary embodiment is characterized in that a flow path forming member is constituted by multiple members (partition walls). In addition, in the second exemplary embodiment, the same reference numerals will be given to the same constituent elements as those in the first exemplary embodiment, and a description thereof will be omitted.

In the same manner as the flow path 21 of the first exemplary embodiment, a flow path 31 of the second exemplary embodiment is also a meander flow path having a portion that extends in the circumferential direction. In this case, the flow path 31 of the second exemplary embodiment is composed of multiple (i.e., four) flow paths 31A, 31B, 31C, and 31D, which extend (obliquely) in the circumferential direction between the inner cylinder 4 and the electrode cylinder 17.

Each of the flow paths 31A, 31B, 31C, and 31D includes one portion, which extends (obliquely) in the first circumferential direction (e.g., in the clockwise direction when viewed from the side of the caulking portion 2A of the outer cylinder 2), and the other portion, which extends (obliquely) in the second circumferential direction, which is opposite to the first circumferential direction, (e.g., in the counterclockwise direction when viewed from the side of the caulking portion 2A of the outer cylinder 2). Thus, because the force of a fluid that flows (obliquely) in the flow path of the second circumferential direction acts in the direction of canceling the force of a fluid that flows (obliquely) in a flow path of the first circumferential direction, the (total) rotational force (torque or moment) applied from the working fluid 20 to the inner cylinder 4 and the electrode cylinder 17 may be reduced.

That is, in the same manner as the flow path 21 of the first exemplary embodiment, the flow path 31 (31A, 31B, 31C, or 31D) of the second exemplary embodiment also includes a clockwise path as a first peripheral path, which extends in the first circumferential direction, a counterclockwise path as a second peripheral path, which extends in the second circumferential direction, and a turning-back path, which interconnects the clockwise path and the counterclockwise path. In addition, in FIGS. 6 and 7, in order to avoid making the drawings complicated, no reference numerals will be given to the clockwise path, the counterclockwise path, and the turning-back path of each flow path 31A, 31B, 31C, or 31D.

The flow paths 31A, 31B, 31C, and 31D are formed by four partition walls 32A, 32B, 32C, and 32D, each of which serves as a flow path forming member. The partition walls 32A, 32B. 32C, and 32D are provided between the inner cylinder 4 and the electrode cylinder 17. The partition walls 32A, 32B, 32C, and 32D extend obliquely in the circumferential direction between the inner cylinder 4 and the electrode cylinder 17, thereby forming the meander flow paths 31A, 31B, 31C, and 31D between the electrode cylinder 17 and the inner cylinder 4.

That is, the partition walls 32A, 32B, 32C, and 32D partition the flow paths 31A, 31B, 31C, and 31D between the inner cylinder 4 and the electrode cylinder 17, and are fixed to the inner cylinder 4 (integrally provided to the inner cylinder 4). Thus, the partition walls 32A, 32B, 32C, and 32D form the flow paths 31A, 31B, 31C, and 31D in which the working fluid 20 flows by the advancing and retracting movements of the piston rod 8 from the upper end side toward the lower end side in the axial direction.

The height (thickness in the radial direction) of each of the partition walls 32A, 32B, 32C, and 32D is, for example, set to be equal to or less than the distance between a portion of the outer circumferential surface of the inner cylinder 4 that is spaced apart from each of the partition walls 32A, 32B, 32C, and 32D and the inner circumferential surface of the electrode cylinder 17. The height and the spacing dimension may be set to be equal to each other in order to suppress the working fluid 20, which flows in the four flow paths 31A, 31B, 31C, and 31D, from flowing to the adjacent flow paths 31A, 31B, 31C, and 31D in the circumferential direction over the respective partition walls 32A, 32B, 32C, and 32D.

As illustrated in the developed view of FIG. 7, like a wavy line such as a sine curve or a cosine curve (e.g., a curved line or a straight line that is turned back in the counterclockwise direction before rotating around the electrode cylinder 17 once in the clockwise direction, or, conversely, a curved line or a straight line that is turned back in the clockwise direction before rotating around the electrode cylinder 17 once in the counterclockwise direction), each of the partition walls 32A, 32B, 32C, and 32D includes one portion, which extends obliquely in the first circumferential direction (e.g., the clockwise direction or the counterclockwise direction), and the other portion, which extends obliquely in the second circumferential direction (e.g., the counterclockwise direction or the clockwise direction), which is opposite to the first circumferential direction.

That is, each of the partition walls 32A, 32B, 32C, and 32D has a first clockwise (right-turn) portion 32A1, 32B1, 32C1, or 32D1, which corresponds to the one portion that extends obliquely in the first circumferential direction, a counterclockwise (left-turn) portion 32A2, 32B2, 32C2, or 32D2, which corresponds to the other portion that extends obliquely in the second circumferential direction, which is opposite to the first circumferential direction, and a second clockwise (right-turn) portion 32A3, 32B3, 32C3, or 32D3, which corresponds to the one portion that extends obliquely in the first circumferential direction. In addition, the terms “clockwise (right-turn)” and “counterclockwise (left-turn)” correspond to the circulation direction of the working fluid 20 when viewing the electrode cylinder 17 (the shock absorber 1) from the upper end side (one end side) in the axial direction, in the same manner as the first exemplary embodiment.

In addition, the first clockwise portion 32A1, 32B1, 32C1, or 32D1 and the counterclockwise portion 32A2, 32B2, 32C2, or 32D2 are connected to each other by a first connecting portion (first turning-back portion) 32A4, 32B4, 32C4, or 32D4. In addition, the counterclockwise portion 32A2, 32B2, 32C2, or 32D2 and the second clockwise portion 32A3, 32B3, 32C3, or 32D3 are connected to each other by a second connecting portion (second turning-back portion) 32A5, 32B5, 32C5, or 32D5.

Here, the respective partition walls 32A, 32B, 32C, and 32D have different circumferential directions depending on the distribution of viscosity of the working fluid 20 in the flow paths 31A, 31B, 31C, and 31D. Specifically, the partition walls 32A, 32B, 32C, and 32D are set in such a manner that no moment (torque or rotational force) is generated due to a shear resistance acting on the respective partition walls 32A, 32B, 32C, and 32D, the inner cylinder 4, and the electrode cylinder 17 when the working fluid 20 flows along the partition walls 32A, 32B, 32C, and 32D. That is, a first relative rotational force (e.g., clockwise force), which is generated by the working fluid 20 flowing in the first circumferential direction, and a second relative rotational force (e.g., counterclockwise force), which is generated by the working fluid 20 flowing in the second circumferential direction and is applied in the direction, which is opposite to that of the first relative rotational force, are close to the same magnitude. In other words, the shapes of the partition walls 32A, 32B, 32C, and 32D are set so that the first relative rotational force and the second relative rotational force are substantially the same.

In this case, each of the partition walls 32A, 32B, 32C, and 32D may not need to have the same axial length in two (clockwise and counterclockwise) directions. For example, the axial length in one (clockwise or counterclockwise) direction may be short (to form a short flow path) on the upstream side (upper end side) having a high pressure (shear resistance), whereas the axial length in the other (counterclockwise or clockwise) direction may be long (to form a long flow path) on the downstream side (lower end side) having a low pressure. The axial length, the peripheral length, and the slope (the amount of inclination) of the one portion (i.e. the portion that extends in the first circumferential direction) and the axial length, the peripheral length, and the slope (the amount of inclination) of the other portion (i.e. the portion that extends in the second circumferential direction) may be adjusted based on, for example, experiments, simulations, or calculation formulas such that the rotational force applied from the working fluid 20 flowing in the flow paths 31 (31A, 31B, 31C, and 31D) to, for example, the inner cylinder 4 and the electrode cylinder 17 reaches a desired value (e.g., so that the sum becomes zero or almost zero).

Here, each of the partition walls 32A, 32B, 32C, and 32D may be formed of an insulator, for example, a polymer material having electrical insulation properties (e.g., a resin material including a synthetic resin or a rubber material including a synthetic rubber). In this case, for example, the respective partition walls 32A, 32B, 32C, or 32D may be integrally formed by covering the outer circumferential surface of the inner cylinder 4 with a mold, which is divided into four parts in the circumferential direction, and injection molding a polymer material to the inner cylinder 4.

Notches 33 make the portions of the flow paths 31A, 31B, 31C, and 31D, which are portions (adjacent portions) adjacent to each other in the axial direction, communicate with each other. Specifically, the notches 33 implement communication between the flow path 31B and the flow path 31C and between the flow path 31C and the flow path 31D, which are adjacent to each other in the axial direction, so as to form a flow path for circulating the working fluid 20. The notches 33 are provided only at the positions of the partition walls 32C and 32D that correspond to the upstream side of the flow path 31. Specifically, the notches 33 are provided in the first clockwise portion 32C1 of the partition wall 32C and the first clockwise portion 32D1 of the partition 32D. The notches 33 are formed as recessed grooves, which extend in the axial direction, by cutting the surfaces of the partition walls 32C and 32D. Thus, the working fluid 20 circulates between the adjacent flow paths 31B and 31C and between the adjacent flow paths 31C and 31D through the notches 33.

The shock absorber 1 according to the second exemplary embodiment has the above-described configuration, and an operation thereof will be described below.

The working fluid 20, introduced into the flow path 31 through the oil holes 4A (four oil holes 4A) in the inner cylinder 4, flows in the flow paths 31A, 31B, 31C and 31D between the partition walls 32A, 32B, 32C, and 32D from the upper end side toward the lower end side between the inner cylinder 4 and the electrode cylinder 17. At this time, a rotational force (torque or moment) is applied to the respective partition walls 32A, 32B, 32C, and 32D, the inner cylinder 4, and the electrode cylinder 17 based on the shear resistance of the working fluid 20 flowing in the flow paths 31A, 31B, 31C, and 31D. However, the force applied from the working fluid 20, which flows between the first clockwise portions 32A1, 32B1, 32C1, and 32D1 and between the second clockwise portions 32A3, 32B3, 32C3, and 32D3 of the respective partition walls 32A, 32B, 32C, and 32D, and the force applied from the working fluid 20, which flows between the counterclockwise portions 32A2, 32B2, 32C2, and 32D2, become opposite to each other (cancel each other). Thus, the entire force applied from the working fluid 20 flowing in the flow paths 31A, 31B, 31C, and 31D may be reduced (canceled in the circumferential direction) as a whole.

In this case, the notches 33 are provided in the partition wall 32C and the partition wall 32D. Thus, a part of the working fluid flowing in the flow path 31B is introduced into the flow path 31C through the notch 33 formed in the partition wall 32C. In addition, a part of the working fluid flowing in the flow path 31C is introduced into the flow path 31D through the notch 33 provided in the partition wall 32D. Thus, for example, soft damping force characteristics may be achieved, compared to a configuration having no notch 33.

In this way, even in the second exemplary embodiment, substantially the same operational effect as in the first exemplary embodiment may be attained. That is, by changing at least one of, for example, the presence/absence of the notches 33, the number, the position, the size, the cross-sectional shape, and the extending direction of the notches 33, the damping force characteristics of the shock absorber 1 may be changed (regulated or tuned) in various ways. Thus, it is possible to easily change and distinguish (identify) the damping force characteristics.

In addition, in the first exemplary embodiment, a case where one flow path 21 is formed using the ring-shaped member 22 between the inner cylinder 4 and the electrode cylinder 17 has been described as an example. However, without being limited thereto, for example, it may be possible to adopt a configuration in which multiple flow paths are provided by changing the shape of the ring-shaped.

In the first exemplary embodiment, a case where the flow path 21 has a meander shape has been described by way of example. However, without being limited thereto, for example, it may possible to adopt a configuration in which the flow path is helically formed so that the working fluid flows only in a given direction (clockwise direction or counterclockwise direction). This is also equally applied to the second exemplary embodiment.

In the first exemplary embodiment, the configuration in which the notches 23 are provided only on the upstream side of the flow path 21 has been described as an example. However, without being limited thereto, for example, it may possible to adopt a configuration in which the notches are provided on the downstream side. Specifically, for example, a configuration in which the notch is provided entirely from the upstream side to the downstream side of a flow path, or a configuration in which the notch is provided only on the downstream side may be possible. This is also equally applied to the second exemplary embodiment.

In the first exemplary embodiment, a case where three notches 23 are provided in total has been described by way of example. However, without being limited thereto, for example, a configuration in which one or two notches are provided, or a configuration in which four or more notches are provided may be possible. In addition, when multiple notches are provided, the multiple notches may be provided in one clockwise portion 22B or one counterclockwise portion 22C. In addition, the thicknesses (the dimension in the radial dimension) and the widths (the dimension in the peripheral dimension) of the multiple notches may be different. In this case, for example, the position, number and the size of the notches may be appropriately set depending on, for example, required performance (damping performance), manufacturing cost, and specifications. This is also equally applicable to the notches 33, which are provided in the partition walls 32A, 32B, 32C, and 32D of the second exemplary embodiment.

In the first exemplary embodiment, a case where the notch 23 is configured to extend in the axial direction has been above as an example. However, without being limited thereto, for example, it may be possible to adopt a configuration in which the notches are configured to extend obliquely with respect to the axial direction (axial center line). In addition, for example, it may be possible to adopt a configuration in which the notches are configured to extend in the circumferential direction. This is also equally applicable to the second exemplary embodiment.

In the first exemplary embodiment, a case where the notch 23 is provided in each of the clockwise portion 22B and the counterclockwise portion 22C has been described as an example. However, without being limited thereto, for example, it may be possible to adopt a configuration in which the notches are provided in the column portion.

In the first exemplary embodiment, the ring-shaped member 22 as the flow path forming member is formed of an insulator. However, without being limited thereto, for example, it may be possible to adopt a configuration in which the ring-shaped member is formed of a material other than an insulator. For example, it may be possible to adopt a configuration in which the ring-shaped member is formed of, for example, a conductive material, a magnetic material, or a non-magnetic material. This is also equally applicable to the second exemplary embodiment.

In the first exemplary embodiment, a case where the ring-shaped member 22, which has been formed in advance, is adhered to the inner cylinder 4 by slight press-fitting and adhesion has been described as an example. However, without being limited thereto, for example, it may be possible to adopt a configuration in which the ring-shaped member is integrally formed by covering the outer circumferential surface of the inner cylinder with a mold, which is divided into four parts in the circumferential direction, and injection molding a polymer material onto the inner cylinder. In this case, for example, it may be possible to adopt a configuration in which, on the outer circumferential surface of the inner cylinder, a positioning groove is provided by recessing a portion, to which the ring-shaped member is adhered, from the remaining portion, and a polymer material such as, for example, a thermosetting resin is injection-molded into the positioning groove.

In the first exemplary embodiment, a case where the notch 23 is formed by cutting (coining) the surface of the ring-shaped member 22 has been described as an example. However, without being limited thereto, for example, it may be possible to adopt a configuration in which the notches are formed by pressing the surface of the ring-shaped member. This is also equally applicable to the second exemplary embodiment.

In the first exemplary embodiment, a case where the working fluid 20 flows from the upper end side to the lower end side in the axial direction has been described as an example. However, without being limited thereto, for example, it may be possible to adopt a configuration in which the working fluid 20 flows from the lower end side to the upper end side in the axial direction, a configuration in which the working fluid 20 flows from the left end side (or the right end side) to the right end side (or the left end side) in the axial direction, or a configuration in which the working fluid 20 flows from the front end side (or the rear end side) to the rear end side (or the front end side) in the axial direction, so long as the working fluid 20 can flow from one end side to the other end side in the axial direction. This is also equally applicable to the second exemplary embodiment.

In the first exemplary embodiment, a case where both axial ends of the electrode cylinder 17 are held by the holding members 10 and 14 has been described as an example. However, without being limited thereto, for example, it may be possible to adopt a configuration in which only one axial end of the electrode cylinder 17 is held by the holding member (e.g., only the upper end side of the electrode cylinder 17 is held by the holding member 10, and the lower end side of the electrode cylinder 17 forms an opening that serves as the outlet for the working fluid 20). This is also equally applicable to the second exemplary embodiment.

In the second exemplary embodiment, a case where the partition walls 32A, 32B, 32C, and 32D, which regulate the direction of the flow paths 31A, 31B, 31C, and 31D, are provided (fixed) on (the outer circumferential side of) the inner cylinder 4 has been described as an example. However, without being limited thereto, for example, it may be possible to adopt a configuration in which the partition walls are provided (fixed) on (the inner circumferential side of) the electrode cylinder. In addition, it may be possible to adopt a configuration in which the partition walls are provided (fixed) on the outer cylinder.

In the second exemplary embodiment, a case where four partition walls 32A, 32B, 32C, and 32D are provided to regulate the direction of the flow paths 31A, 31B, 31C, and 31D has been described as an example. However, without being limited thereto, for example, it may be possible to adopt a configuration in which two or three partition walls are provided, or a configuration in which five or more partition walls are provided. In that case, the number of partition walls may be appropriately set depending on, for example, required performance (damping performance), manufacturing cost, and specifications.

In the second exemplary embodiment, a case where the respective partition walls 32A, 32B, 32C, and 32D are integrally formed, for example, by covering the outer circumferential surface of the inner cylinder 4 with a mold, which is divided into four parts in the circumferential direction, and injection molding a polymer material to the inner cylinder 4 has been described as an example. However, without being limited thereto, for example, it may be possible to adopt a configuration in which partition walls, which have been formed in advance, are bonded to the inner cylinder. In this case, for example, it may be possible to adopt a configuration in which, on the outer circumferential surface of the inner cylinder, positioning grooves are provided by recessing portions, to which the respective partition walls are bonded, from the remaining portion, and bonding the partition walls to the respective positioning grooves. In addition, a configuration m which a covering member, in which partition walls are provided so as to protrude from a sheet-shaped (plate-shaped) member, which may cover the outer circumferential side of the inner cylinder over the entire circumferential direction, has been formed in advance and is wound around the inner cylinder may be possible.

In the respective embodiments, a case where the shock absorber 1 is disposed in the vertical direction has been described as an example. However, without being limited thereto, for example, the shock absorber may be disposed in a desired direction depending on an object to which the shock absorber is attached, such as, for example, be inclined within a range not causing aeration.

In the respective embodiments, a case where the working fluid 20 as a functional fluid is constituted by the electrorheological fluid (ER fluid) has been described as an example. However, the present invention is not limited thereto, and for example, the working fluid as a functional fluid may be constituted using a magnetic fluid (MR fluid), properties of which are changed by, for example, a magnetic field. When the magnetic fluid is used, the electrode cylinder 17 as a cylinder member is used as a magnetic pole, other than an electrode. In this case, for example, when a magnetic field is generated between the inner cylinder 4 and the cylinder member (magnetic pole cylinder) and the generated damping force is variably regulated, the magnetic field may be variably controlled from the outside. In addition, for example, the insulating holding members 10 and 14 may be formed of, for example, a non-magnetic material.

In the respective embodiments, a case where the shock absorber 1 as a cylinder device is used for a four-wheeled vehicle has been described by way of example. However, without being limited thereto, for example, the shock absorber 1 may be widely used as various shock absorbers (cylinder devices) for absorbing shocks from a target object such as, for example, a shock absorber used for a two-wheeled vehicle, a shock absorber used for a railway vehicle, a shock absorber used for various mechanical devices including general industrial devices, and a shock absorber used for a building.

In addition, of course, the respective embodiments are provided by way of example and it is possible to partially substitute or combine the configurations illustrated in different embodiments.

According to the above embodiments, it is possible to easily change and distinguish (identify) damping force characteristics.

That is, according to the embodiments, the flow path forming member is formed with notches, which make the portions of flow paths, which are adjacent to each other in the axial direction, communicate with each other. Therefore, for example, the cylinder device in which the flow path forming member having the notches is mounted may achieve damping force characteristics different from those of a cylinder device, which differs from the cylinder device according to the embodiments only in terms that no notch is formed therein. In addition, the cylinder device may achieve different damping force characteristics by changing the number of notches.

That is, by changing at least one of, for example, the presence/absence of the notch, the number, the position, the size, the cross-sectional shape, and the extending direction of the notches, the damping force characteristics of the cylinder device may be changed (regulated or tuned) in various ways. In this case, it is easy to visually determine (distinguish or identify) the difference in, for example, the number, the position, the size, the cross-sectional shape, and the extending direction of the notches 23, compared to a case of visually determining, for example, the difference in the angle of the helical members. Thus, the management of elements may be easily performed.

Moreover, it is possible to change the damping force characteristics in various ways by changing at least one of, for example, the number, position, size, cross-sectional shape, and extending direction of the notches formed in the flow path forming member. Therefore, it may be easy to change (regulate) the damping force characteristics in various ways. In addition, the damping force characteristics may be changed (regulated) in various ways by manufacturing the flow path forming member having no notch, and thereafter forming the notches in the flow path forming member so as to achieve desired damping force characteristics. Therefore, elements may be used in common, which may reduce mass production costs.

According to the embodiments, the notches may be provided only on the upstream side of the flow path forming member in which the functional fluid flows. In this case, the damping force characteristics may be changed (regulated) in various ways by the notch provided at a position at which the pressure of the functional fluid is high. Therefore, for example, even if the number of notches is not greatly changed (e.g., even if the difference in the number of notches is set to one), the damping force characteristics may be changed. Thus, the degree of freedom of changing (regulating) the damping force characteristics may be increased (the range within which the damping force characteristics may be changed may be increased).

According to the embodiments, the flow path forming member is formed of an insulator. Therefore, even if the flow path forming member is in contact with both a cylinder member, which serves as the electrode cylinder, and the inner cylinder, the cylinder member and the inner cylinder may be electrically insulated from each other.

According to the embodiment, the notches are configured so as to extend in the axial direction. In this case, the functional fluid may be circulated in the notches in the axial direction. That is, the damping force characteristics may be changed (regulated) in various ways by the notches, which may linearly circulate the functional fluid from one side to the other side in the axial direction. Even in this case, for example, even if the number of notches is not greatly changed (e.g., even if the difference in the number of notches is set to one), the damping force characteristics may be changed. Thus, the degree of freedom of changing (regulating) the damping force characteristics may be increased (the range within which the damping force characteristics may be changed may be increased).

The cylinder device based on the above embodiments may be, for example, those of the aspects described below. The cylinder device of a first aspect includes: an inner cylinder in which a function fluid, a property of which is changed by an electric field or a magnetic field, is encapsulated and into which a rod is inserted; a cylinder member provided outside the inner cylinder and functioning as an electrode or a magnetic pole; and a flow path forming member provided between the inner cylinder and the cylinder member so as to form one flow path or a plurality of flow paths in which the functional fluid flows from one end side to the other end side of the cylinder device in an axial direction by advancing and retracting movements of the rod. The flow path is a helical or meander flow path having a portion that extends in a circumferential direction, and the flow path forming member has a notch formed therein to make portions of the flow path, which are adjacent to each other in the axial direction, communicate with each other.

According to a second aspect, in the first aspect, the notch is provided only on an upstream side of the flow path forming member in which the functional fluid flows.

According to a third aspect, in the first or second aspect, the flow path forming member is formed of an insulator.

According to a fourth aspect, in any one of the first to third aspects, wherein the notch is formed so as to extend in the axial direction.

In the foregoing, several exemplary embodiments of the present invention have been described above in order to facilitate understanding of the present invention without limiting the present invention. The present invention may be changed or improved without departing from the idea thereof, and of course, the equivalents of the present invention are included in the present invention. It is possible to arbitrarily combine or omit respective constituent elements described in the claims and specification in a range in which at least a part of the above described problems can be solved, or a range in which at least a part of the effects can be exhibited.

This application claims priority based on Japanese Patent Application No. 2015-192850 filed on Sep. 30, 2015. All disclosures including the specification, claims, drawings, and abstract of Japanese Patent Application No. 2015-192850 filed on Sep. 30, 2015 is hereby incorporated herein by reference in their entirety.

### DESCRIPTION OF SYMBOLS

1: shock absorber (cylinder device)
2: outer cylinder
4: inner cylinder
8: piston rod (rod)
17: electrode cylinder (cylinder member)
20: working fluid (fluid, functional fluid)
21, 31(31A, 31B, 31C, 31D): flow path
21A: clockwise path (a portion that extends in the circumferential direction, an axially adjacent portion)
21B: counterclockwise path (a portion that extends in the circumferential direction, an axially adjacent portion)
22: ring-shaped member (flow path forming member)
23, 33: notch
32A, 32B, 32C, 32D: partition wall (flow path forming member)

1. A cylinder device comprising:
an inner cylinder in which a function fluid, a property of which is changed by an electric field or a magnetic field, is encapsulated and into which a rod is inserted;
a cylinder member provided outside the inner cylinder and functioning as an electrode or a magnetic pole; and
a flow path forming member provided between the inner cylinder and the cylinder member so as to form one flow path or a plurality of flow paths in which the functional fluid flows from one end side to the other end side of the cylinder device in an axial direction by advancing and retracting movements of the rod,
wherein the flow path is a helical or meander flow path having a portion that extends in a circumferential direction, and
the flow path forming member has a notch formed therein to make portions of the flow path, which are adjacent to each other in the axial direction, communicate with each other.

2. The cylinder device of claim 1, wherein the notch is provided only on an upstream side of the flow path forming member in which the functional fluid flows.

3. The cylinder device of claim 1, wherein the flow path forming member is formed of an insulator.

4. The cylinder device of claim 1, wherein the notch is formed to extend in the axial direction.
